(19) United States
(12) Patent Application Publication
(10) Pub. No.: US 2023/0386359 A1
(43) Pub. Date: Nov. 30, 2023

(54) MATHEMATICAL LEARNING GAME

(71) Applicant: Colin Michael Breen, Lombard, IL (US)

(72) Inventor: Colin Michael Breen, Lombard, IL (US)

(21) Appl. No.: 17/804,320

(22) Filed: May 27, 2022

(51) Int. Cl. G09B 19/02; G09B 1/32

(52) U.S. Cl. CPC G09B 19/02; G09B 1/32

(57) ABSTRACT

A mathematical learning game that facilitates engagement through playing cards that define the target mathematical equations that opposing teams attempt to solve first to win battles against each other. The mathematical equations interplay with the results of rolled dice, wherein these rolled results provide the operand of the mathematical equations. The playing cards also provide a character narrative and/or a set of actions or rules that enhances and/or defines the rewards of correctly solving the mathematical equation first.

### BACKGROUND OF THE INVENTION

The present invention relates to teaching and learning aids and tools, and, more particularly, an educational playing card and dice game which helps kids practice their math skills.

Unfortunately, a vast majority of children dislike practicing their math skills. Which is unfortunate because a child's math knowledge can be precious skillset fueling that individual's intellectual growth: a solid foundation in mathematics develops and hones the skills of logical reasoning, ordering and analyzing data, recognizing patterns, seeking evidence, conclusions and proof, and solving problems. Accordingly, the desire exists for new, different, and exciting educational games that are easy to play and interesting as well as entertaining. Current educational math games, however, typically fail to engage children. One reason for this is that many math games only involve dice, wherein the players simply practice operations with whole numbers, and are not combining the random outcomes of dice with another variable, such as those offered through the machinations of playing card play. Furthermore, current math games, the inventor submits, are missing a narrative premise to get children invested in the actions of the game.

In short, math dice games do not have an engaging narrative, they simply practice match skills by rolling dice. Or put another way, there is no existing math-based game which utilizes unique character-based playing cards with unique playing card effects associated with the character on the playing card.

As can be seen, there is a need for an entertaining game that is particularly engaging through the employment of the machinations of playing cards in combination with the roll of the dice. The playing cards provide a set of rules defining the mathematical function players need to correctly answer to be rewarded, and wherein the play cards also provide a character narrative and/or a set of actions or rules that enhances and/or defines the rewards, to significantly aiding in the teaching of math skills through rewarding players for correctly completing math operations.

The premise of the game (colloquially known as “Robo Wars”) is a battle between two teams, wherein each team is assigned a predetermined amount of ‘hit points’ that can be ‘damaged’ through the opposing team correctly solving math problems that are functions of inputs from both playing cards and dice. Each team can defend itself by correctly solving the instant math problem first. For example, each playing card provides a mathematical equation or function, wherein rolled dice provide the operands or input quantities for the one or more mathematical operations embodied in the mathematical equation or function. And each team tries to correctly solve the mathematical equation first.

The excitement of beating opposing players or team is heightened by a characterization, narrative premise, effect and/or action defined in a set of action instructions on the playing card that established the mathematical equation or function. Each playing card may develop characters and one or more related narratives through artwork and text along a character indicia portion of the playing card, thereby encouraging younger participants to practice the math skills required to play and win the game to further the narrative or develop the character. The one or more narratives may be associated with the effect, action, or machination defined in the set of action instructions that further defines the mathematical operation, thereby the players hone their math skills through being incentivized through the engaging rewards. In short, the additional component of a unique playing card effect allows for a large variety of outcomes associated with winning, which encourages the players to want to play the game again.

### SUMMARY OF THE INVENTION

In one aspect of the present invention, a mathematical learning game having the following: a hit point count for each player; a plurality of game dice, each die having a plurality of die faces; a plurality of playing cards each having a set of action instructions thereon, the set of action instructions comprising: at least one mathematical operation question; and a dice indicator; and the set of action instructions and dice indicator being useable during game play to indicate the mathematical operation question being presented, wherein the dice indicator being useable during game play to indicate a number of the plurality of game dice to be rolled, wherein each rolled die face is an operand of the mathematical operation question.

In another aspect of the present invention, the mathematical learning game further includes the following the set of action instructions further having an action instruction being useable during game play to indicate a reduction or an increase in the hit point count for a player having a correct mathematical operation answer to the presented mathematical operation question, wherein each die face has a set of two numbers, wherein each playing card provides a playing card type indicator indicating a sequence of playing said playing card, wherein said mathematical operation questions on the plurality of playing cards are taken from the group consisting of addition, subtraction, multiplication and division, and wherein each playing card provides a character indicia portion indicating a character associated with the card.

In yet another aspect of the present invention, a method of playing a mathematical learning game includes providing the above-mentioned mathematical learning game and assigning players into two teams; assigning a hit point count and a predetermined number of playing cards of the plurality of playing cards for each team; and taking turns between the two teams.

These and other features, aspects and advantages of the present invention will become better understood with reference to the following drawings, description and claims.

### BRIEF DESCRIPTION OF THE DRAWINGS

FIG. 1 is a process flow chart of an exemplary embodiment of the present invention, illustrating a game flow.

FIG. 2 is a flow chart of an exemplary embodiment of a turn of the present invention.

FIG. 3 is a schematic view of an exemplary embodiment of a playing card of the present invention.

FIG. 4 is a schematic view of an exemplary embodiment of a hit token of the present invention.

FIG. 5 is a schematic view of an exemplary embodiment of a miss token of the present invention.

FIG. 6 is a schematic view of a plurality of exemplary die faces of the present invention.

FIG. 7 is a front view of an exemplary embodiment of the FIG. 2 playing card.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

Broadly, an embodiment of the present invention provides a mathematical learning game that facilitates engagement through playing cards that define the target mathematical equations that opposing teams attempt to solve first to win battles against each other. The mathematical equations interplay with the results of rolled dice, wherein these rolled results provide the operand of the mathematical equations. The playing cards also provide a character narrative and/or a set of actions or rules that enhances and/or defines the rewards of correctly solving the mathematical equation first.

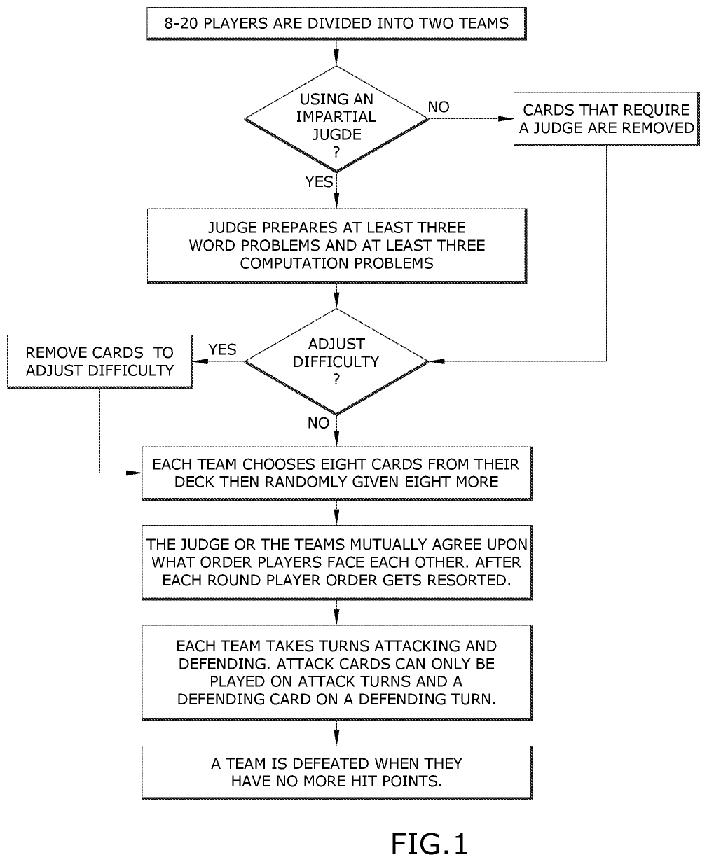

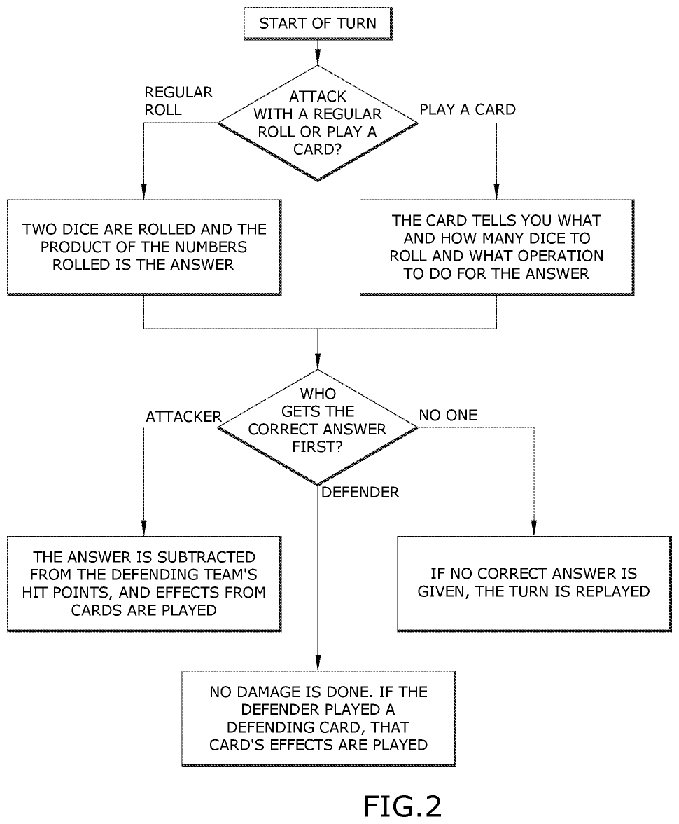

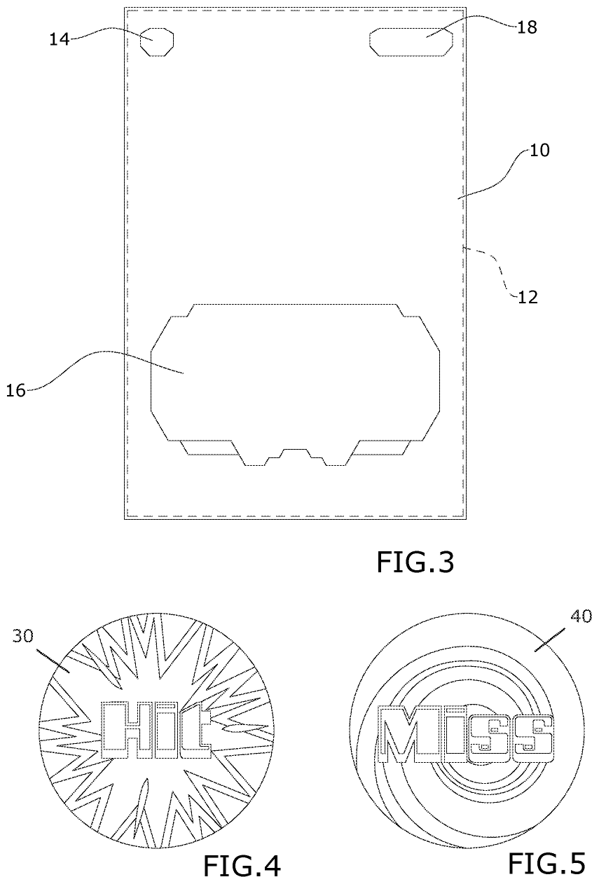

Referring now to FIGS. 1 through 7, the present invention may include a deck of playing cards 10, wherein each playing card has a character indicia portion 12, a playing card type indicator 14, a set of action instructions 16, and a dice indicator 18. The unique playing cards 10 are critical to the game flow and is outcome determinative. The present invention includes game dice 20 with unconventional sets of numbers provide along different facets of each die 20. The game may also include hit tokens 30 and miss tokens 40. The present invention also includes a game manual. The hit token 30 may list a hit point count for each player.

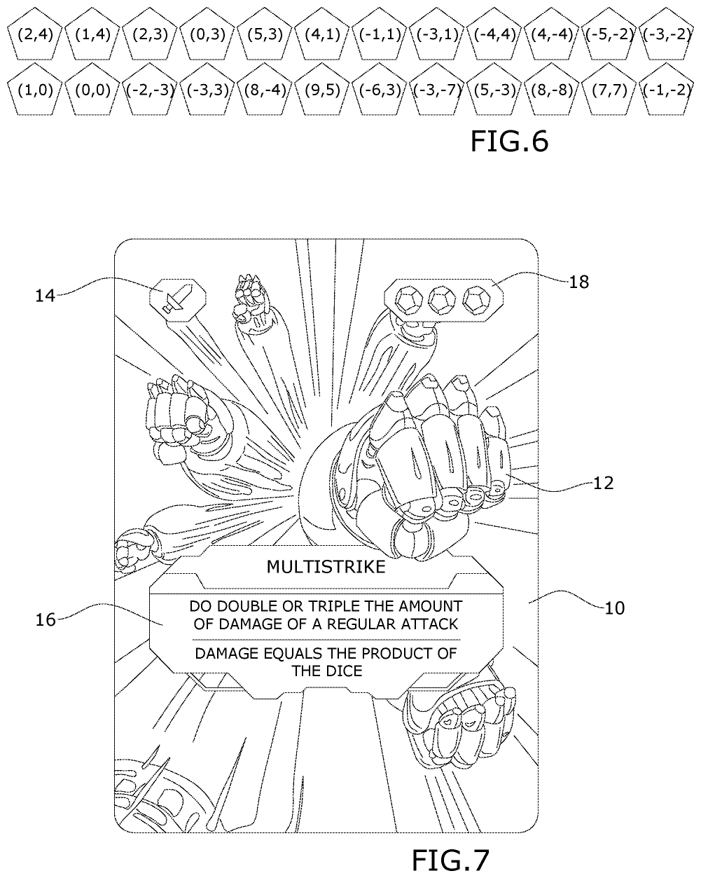

The present invention is played by two or more players or teams, each being assigned a predetermined number of hit points and selecting a predetermined number of playing cards 10 from a deck. Each playing card 10 in the deck contains an image of character which as a unique ability to achieve a desired outcome in game, this character image or artwork may be embodied in the character indicia portion 12, as illustrated in FIG. 7. The goal of the game is the reduce the opposing players' or team's hit points to zero through winning battles by correctly solving mathematical equations first. Effects or rules may be provided along the set of action instructions 16 portion of each playing card 10 played, wherein the rules may increase or decrease the reduction of hit points, or otherwise heal previously lost hit points. Also, the effects may enable players to draw, steal, or destroy playing cards 10. To effectuate these playing card effects the player may roll the dice 20 pictured on the dice indicator 18 of that playing card 10. The dice 20 contain numbers which are used to solve the relevant mathematical operation or operations defined through the set of action instructions 16 portion. In certain embodiments, the facet or face of a die 10 may have a set of two numbers, as illustrated in FIG. 6, thereby availing players to a greater number of mathematical operations, permutations or relationships.

Each turn may begin with a regular roll of a die 20 or play of a playing card 10. For instance, two dice 20 may be rolled and the product of the numbers rolled (e.g., from the set of two numbers) is the correct answer. When a playing card 10 is played, the playing card 10 defines or further defines the equation to be solved by, in some embodiments, instructing how many dice are rolled and what operation or operations is or are required for obtaining the correct answer. Common mathematical operations such as addition, subtraction, multiplication, and division, as well as knowledge of mathematical relationships may be demanded.

Game play contemplates that each turn, whichever team first answers the mathematical equation, function, or operation correctly, reaps the benefit. If the attacking team is the first to answer correctly, the answer or a set number is subtracted from the defending teams hit point, and the effect/action based on the set of action instructions 16 are implemented to the benefit of the attacker. If the defending team answers correctly first, then no damage is done, and the effect/action based on the set of action instructions 16 are implemented to the benefit of the defender. If there is not correct answer, the turn may be replayed. In one embodiment, if the player/team that played the playing card 10 wins, then they implement or effectuate the effect/action of the playing card 10.

The teams take turns cycling through attack and defend modes, each team having the opportunity to attack, which means they can play a playing card 10. The other team must defend and calculate the math operation first to be successful.

A method of making the making the present invention may include the following. A manufacturer would need to print a deck of unique playing cards of playing card dimensions. They would also need to create a plurality of unique dice 20. It is critical to having set of uniquely printed playing cards.

A method of using the present invention includes the following. The game embodied in the present invention is played by a group of people divided into two teams. These two teams select a predetermined amount of (e.g., eight) playing cards from their deck and another eight playing cards are randomly given to them. Each playing card 10 may have the character indicia portion 12, the playing card type indicator 14, the set of action instructions 16, and the dice indicator 18. The playing card type icon 14 distinguishes between a defense playing card and an attacking playing card. The set of action instructions 16 further define the mathematical equation to be solved as well as an action/effect that the team possessing the playing card 10 effectuates upon a precondition (e.g., it is their turn as attacker or they successfully answered the mathematical equation first). For instance, the action may be for the associated team to add hit points to a predefined damage or make the damage a function of a roll of the dice or the like. The dice indicator 18 informs the player the number of dice that are to be rolled during an attack or in response to the action from the set of action instructions 16.

The game may include an impartial judge who facilitates game play. The judge may prepare a plurality of word problems and computation problems that are utilized during game play or to break ties. The judge may be empowered to adjust the difficulty of play. The judge may decide which team start in attack or defense mode. The judge may resort teams after each round. The designated judge may be given an answer chart containing the correct answers to all the mathematical equation and operation questions in the game. Alternatively, playing cards can be used to facilitate these judge functions.

The two teams then take turns attacking or defending. Each team has an agreed-upon number of hit points. The attacking team can choose an attacking playing card to play and is able to do damage if they win their turn. The defending team can play a defending playing card and can avoid or deflect damage. Each turn requires the players solve a math operation using numbers from a set of rolled dice. The team which reduces the other teams hit points to zero wins.

As used in this application, the term “about” or “approximately” refers to a range of values within plus or minus 10% of the specified number. And the term “substantially” refers to up to 90% or more of an entirety. Recitation of ranges of values herein are not intended to be limiting, referring instead individually to any and all values falling within the range, unless otherwise indicated, and each separate value within such a range is incorporated into the specification as if it were individually recited herein. The words “about,” “approximately,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the described embodiments. The use of all examples, or exemplary language (“e.g.,” “such as,” or the like) provided herein, is intended merely to better illuminate the embodiments and does not pose a limitation on the scope of the embodiments or the claims. No language in the specification should be construed as indicating any unclaimed element as essential to the practice of the disclosed embodiments.

In the following description, it is understood that terms such as “first,” “second,” “top,” “bottom,” “up,” “down,” and the like, are words of convenience and are not to be construed as limiting terms unless specifically stated to the contrary.

It should be understood, of course, that the foregoing relates to exemplary embodiments of the invention and that modifications may be made without departing from the spirit and scope of the invention as set forth in the following claims.

What is claimed is:

1. A mathematical learning game comprising:
a hit point count for each player;
a plurality of game dice, each die having a plurality of die faces;
a plurality of playing cards each having a set of action instructions thereon, the set of action instructions comprising:
at least one mathematical operation question; and
a dice indicator; and
the set of action instructions and dice indicator being useable during game play to indicate the mathematical operation question being presented, wherein the dice indicator being useable during game play to indicate a number of the plurality of game dice to be rolled, wherein each rolled die face is an operand of the mathematical operation question.

2. The mathematical learning game of claim 1, wherein the set of action instructions further comprises an action instruction being useable during game play to indicate a reduction or an increase in the hit point count for a player having a correct mathematical operation answer to the presented mathematical operation question.

3. The mathematical learning game of claim 2, wherein each die face has a set of two numbers.

4. The mathematical learning game of claim 3, wherein each playing card provides a playing card type indicator indicating a sequence of playing said playing card.

5. The mathematical learning game of claim 4, wherein said mathematical operation questions on the plurality of playing cards are taken from the group consisting of addition, subtraction, multiplication, and division.

6. The mathematical learning game of claim 5, wherein each playing card provides a character indicia portion indicating a character associated with the card.

7. A method of playing a mathematical learning game, the method comprising:
providing the mathematical learning game of claim 1;
assigning players into two teams;
assigning a hit point count and a predetermined number of playing cards of the plurality of playing cards for each team; and
taking turns between the two teams.
